(19) United States
(12) Patent Application Publication
(10) Pub. No.: US 2016/0168369 A1
(43) Pub. Date: Jun. 16, 2016

(54) ETHYLENE-BASED POLYMER COMPOSITIONS FOR BLOW MOLDING APPLICATIONS

(71) Applicant: DOW GLOBAL TECHNOLOGIES LLC, Midland, MI (US)

(72) Inventors: John L. Sugden, Saginaw, MI (US); John O. Osby, Lake Jackson, TX (US)

(21) Appl. No.: 14/903,395

(22) PCT Filed: Aug. 6, 2014
(86) PCT No.: PCT/US2014/050006

§ 371 Date: Jan. 7, 2016

Related U.S. Application Data
(60) Provisional application No. 61/864,169, filed on Aug. 9, 2013.

(51) Int. Cl. C08L 27/20; C08L 23/08

(52) U.S. Cl. CPC C08L 27/20; C08L 23/0815; C08L 2205/06

(57) ABSTRACT

The invention provides a composition comprising at least the following components: A) an ethylene-based polymer comprising the following properties: a) a high load melt index (I21) from 10 to 100 g/10 min, b) a density from 0.940 to 0.965 g/cc; B) from 20 ppm to 120 ppm, based on the weight of the composition, of at least one fluoropolymer comprising, in polymerized form, at least one vinylidene fluoride monomeric unit and at least one hexafluoropropylene monomeric unit; C) at least one polyalkylene oxide; and D) from 500 ppm to 2000 ppm, based on the weight of the composition, of at least one metal stearate.

### REFERENCE TO RELATED APPLICATIONS

The present application claims the benefit of U.S. Provisional Application 61/864,169, filed on Aug. 9, 2013.

### BACKGROUND

Die build-up often occurs in blow molding processes. To reduce die build-up a polymer formulation containing various additives, including one or more processing aids, is often added to the extrudate, to coat on the metal of the die over time, to prevent the extrudate from adhering to the metal. However, one or more additives in a polymer formulation may volatilize under the extrusion conditions used in blow molding applications, and create residue deposits on blow pins and other mold surfaces. Also, the additive formulation may change the amount of gloss in the final product. Thus, there is a need for new polymer compositions that can be used in blow molding processes, and which reduce die build-up and deposits on blow pins and other mold surfaces. There is a further need for such polymer compositions that will not alter the gloss in the final product. These needs have been met by the following invention.

### SUMMARY OF THE INVENTION

The invention provides a composition comprising at least the following components:

A) an ethylene-based polymer comprising the following properties:
a) a high load melt index (I21) from 10 to 100 g/10 min,
b) a density from 0.940 to 0.965 g/cc;

B) from 20 ppm to 120 ppm, based on the weight of the composition, of at least one fluoropolymer comprising, in polymerized form, at least one vinylidene fluoride monomeric unit and at least one hexafluoropropylene monomeric unit;

C) at least one polyalkylene oxide; and

D) from 500 ppm to 2000 ppm, based on the weight of the composition, of at least one metal stearate.

### DETAILED DESCRIPTION

The present invention provides ethylene-based polymer compositions, and articles prepared from the same. The compositions of the invention have improved processibility, and are particularly suitable for use in blow molding processes.

As discussed above, the invention provides a composition comprising at least the following components:

A) an ethylene-based polymer comprising the following properties:
a) a high load melt index (I21) from 10 to 100 g/10 min,
b) a density from 0.940 to 0.965 g/cc;

B) from 20 ppm to 120 ppm, further from 20 ppm to 100 ppm, further from 20 ppm to 80 ppm, further from 20 ppm to 50 ppm, based on the weight of the composition, of at least one fluoropolymer comprising, in polymerized form, at least one vinylidene fluoride monomeric unit and at least one hexafluoropropylene monomeric unit;

C) at least one polyalkylene oxide; and

D) from 500 ppm to 2000 ppm, further from 600 ppm to 1800 ppm, further from 800 ppm to 1500 ppm based on the weight of the composition, of at least one metal stearate.

An inventive composition may comprise a combination of two or more embodiments as described herein.

A component of an inventive composition may comprise a combination of two or more embodiments as described herein.

In one embodiment, component B is present in an amount from 20 ppm to 55 ppm, further from 25 ppm to 50 ppm, further from 30 ppm to 45 ppm, based on the weight of the composition.

In one embodiment, component B is selected from the following: i) poly(vinylidene fluoride-co-hexafluoropropylene), ii) poly(vinylidene fluoride-co-hexafluoropropylene-co-tetrafluoroethylene), or iii) a combination thereof.

In one embodiment, component B is a vinylidene fluoride hexafluoropropylene polymer.

In one embodiment, the fluoropolymer of component B comprising, in polymerized form, at least ten vinylidene fluoride monomeric units, and at least ten hexafluoropropylene monomeric units. In a further embodiment, the fluoropolymer of component B comprising, in polymerized form, at least 100 vinylidene fluoride monomeric units, and at least 100 hexafluoropropylene monomeric units.

In one embodiment, component B is selected from Formula 1:

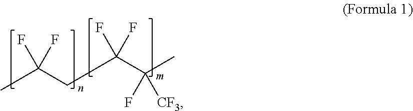

wherein m≧1, n≧1. In a further embodiment, m is from 10 to 1000, further from 10 to 500, and n is from 10 to 1000, further from 10 to 500.

Suitable fluoropolymers include, but are not limited to, those available in polymer processing formulations from 3M; for example, DYNAMAR FX-5920A Polymer Processing Additive and DYNAMAR FX-5920B Polymer Processing Additive.

In one embodiment, component D is selected from the following: calcium stearate, magnesium stearate, potassium stearate, zinc stearate, or combinations thereof. In a further embodiment, component D is selected from calcium stearate, magnesium stearate, zinc stearate, or combinations thereof. In a further embodiment, component D is selected from calcium stearate, zinc stearate, or combinations thereof.

In one embodiment, component D is present in an amount from 900 to 1200 ppm, further from 950 to 1100 ppm, based on the weight of the composition.

In one embodiment, the polyalkylene oxide of component C is selected from Formula 2:

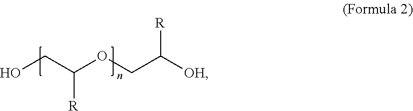

wherein each R is, independently, H, CH₃ or CH₂CH₃, further independently, H or CH₃, and further H; and n is from 2 to 100,000, further 10 to 100,000, further from 10 to 10,000, further from 10 to 1000, further from 10 to 500.

In one embodiment, the polyalkylene oxide of component C is polyethylene oxide.

In one embodiment, component C is present in an amount from 50 ppm to 200 ppm, further from 60 ppm to 180 ppm, further from 70 ppm to 150 ppm, further from 80 ppm to 120 ppm, further from 80 ppm to 110 ppm, further from 80 ppm to 100 ppm, based on the weight of the composition.

In one embodiment, component C is present in an amount from 50 ppm to 300 ppm, further from 60 ppm to 290 ppm, further from 70 ppm to 280 ppm, further from 80 ppm to 270 ppm, further from 80 ppm to 260 ppm, based on the weight of the composition.

Suitable polyalkylene oxides include, but are not limited to, those available in polymer processing formulations from 3M; for example, DYNAMAR FX-5920A Polymer Processing Additive and DYNAMAR FX-5920B Polymer Processing Additive.

In one embodiment, the weight ratio of component D to component B is from 15 to 100, further from 16 to 70, further from 18 to 50, further from 20 to 40.

In one embodiment, the weight ratio of component D to component B is from 15 to 50, further from 20 to 45, and further from 22 to 35.

In one embodiment, the weight ratio of component D to component B is from 8 to 100, further from 8 to 70, further from 8 to 50, further from 8 to 40.

In one embodiment, the weight ratio of component D to component B is from 8 to 50, further from 8 to 45, and further from 8 to 35.

In one embodiment, the composition has a molecular weight distribution (M_{w}/Mₙ) from 8 to 25, further from 10 to 20, as determined by GPC.

In one embodiment, the composition has a density from 0.945 to 0.965 g/cc, further from 0.955 to 0.960 g/cc (1 cc=1 cm³).

In one embodiment, the composition has a melt index I₂ (190° C., 2.16 kg weight)) from 0.1 to 3.0 g/10 min, further from 0.1 to 2.0 g/10 min, further from 0.1 to 1.0 g/10 min, further from 0.1 to 0.5 g/10 min

In one embodiment, the composition has a high load melt index I₂₁ (190° C., 21.6 kg weight) from 10 to 40 g/10 min, further from 20 to 35 g/10 min, further from 22 to 32 g/10 min.

In one embodiment, the composition comprises greater than, or equal to, 80 weight percent, further greater than, or equal to, 85 weight percent, further greater than, or equal to, 90 weight percent of the ethylene-based polymer, based on the weight of the composition.

In one embodiment, the composition comprises greater than, or equal to, 92 weight percent, further greater than, or equal to, 95 weight percent, further greater than, or equal to, 98 weight percent of the ethylene-based polymer, based on the weight of the composition.

An inventive composition may comprise a combination of two or more embodiments as described herein.

The ethylene-based polymer of component A may comprise a combination of two or more embodiments as described herein.

The fluoropolymer of component B may comprise a combination of two or more embodiments as described herein.

The polyalkylene oxide of component C may comprise a combination of two or more embodiments as described herein.

The metal stearate of component D may comprise a combination of two or more embodiments as described herein.

### Ethylene-Based Polymer

In one embodiment, the ethylene-based polymer comprises a high molecular weight (HMW) ethylene-based polymer and a low molecular weight (LMW) polyethylene-based polymer. The ethylene-based polymer may be made by physical blending or in situ blending.

The ethylene-based polymer can be prepared in situ, in a single reactor, or in more than one reactor configuration. If the ethylene-based polymer is prepared in situ, in a dual reactor configuration, the polymer made in the first reactor can be either the HMW polymer or the LMW polymer as described herein. The polymer in the second reactor has a density and melt flow rate such that the overall density and melt flow rate of the ethylene-based polymer are met. Typically, if, in the first reactor, a HMW polymer is made, in the second reactor relatively little or no comonomer is used, and relatively a high hydrogen concentration is used, to obtain the overall melt flow rate and density of the final composition. Similar polymerization processes are described in WO2004101674A, incorporated herein by reference.

In one embodiment, the ethylene-based polymer has a density greater than, or equal to, 0.945 g/cc, further greater than, or equal to, 0.950 g/cc, further greater than, or equal to, 0.955 g/cc. In one embodiment, the ethylene-based polymer has a density less than, or equal to, 0.965 g/cc, further less than, or equal to, 0.960 g/cc. In one embodiment, the ethylene-based polymer has a density from 0.945 to 0.965 g/cc, and further from 0.950 to 0.962 g/cc, and further from 0.955 to 0.960 g/cc.

In one embodiment, the ethylene-based polymer has a high load melt index (I₂₁) less than, or equal to, 50 g/10 min, further less than, or equal to, 40 g/10 min, further less than, or equal to, 30 g/10 min. In one embodiment, the ethylene-based polymer has a high load melt index (I₂₁) greater than, or equal to, 10 g/10 min, further greater than, or equal to, 15 g/10 min, and further greater than, or equal to, 20 g/10 min. In one embodiment, the ethylene-based polymer has a high load melt index (I₂₁) from 10 to 50 g/10 min, further from 15 to 40 g/10 min, and further from 20 to 30 g/10 min.

In one embodiment, the ethylene-based polymer has a melt index (I₂) less than, or equal to, 1.0 g/10 min, further less than, or equal to, 0.7 g/10 min, further less than, or equal to, 0.5 g/10 min. In one embodiment, the ethylene-based polymer has a melt index (I₂) greater than, or equal to, 0.1 g/10 min, and further greater than, or equal to, 0.2 g/10 min. In one embodiment, the ethylene-based polymer has a melt index (I₂) from 0.1 to 1.0 g/10 min, further from 0.2 to 0.7 g/10 min, and further from 0.2 to 0.5 g/10 min.

In one embodiment, the ethylene-based polymer has a molecular weight distribution, characterized by the ratio (M_{w}/Mₙ) of the weight average molecular weight (M_{w}) to the number average molecular weight (Mₙ), greater than, or equal to, 10, further greater than, or equal to, 12, further greater than, or equal to, 15, as determined by GPC (Cony. Gel Permeation Chromatography).

In one embodiment, the ethylene-based polymer has a molecular weight distribution less than, or equal to, 35, further less than, or equal to, 20, further less than, or equal to, 25, as determined by GPC (Cony. Gel Permeation Chromatography).

In one embodiment, the high molecular weight ethylene-based polymer is present in an amount greater than, or equal to, 40 weight percent, further greater than, or equal to, 45 weight percent, further greater than, or equal to, 50 weight percent, based on the sum weight of the high molecular weight ethylene-based polymer and the low molecular weight ethylene-based polymer. In one embodiment, the low molecular weight ethylene-based polymer is present in an amount less than, or equal to, 60 weight percent, further less than, or equal to, 55 weight percent, and further less than, or equal to, 50 weight percent, based on the sum weight of the high molecular weight ethylene-based polymer and the low molecular weight ethylene-based polymer.

In one embodiment, the weight ratio of the high molecular weight component to the low molecular weight component (HMW/LMW) is from 40/60 to 70/30, further from 45/55 to 67/33, and further from 50/50 to 65/35.

Suitable ethylene-based polymers include, but are not limited to, CONTINUUM DMDA 6620 High Density Polyethylene Resin, available from The Dow Chemical Company.

The ethylene-based polymer may comprise a combination of two or more embodiments as described herein.

The components of an ethylene-based polymer may comprise a combination of two or more embodiments as described herein.

### The High Molecular Weight (HMW) Polymer Component

In one embodiment, the high molecular weight ethylene-based polymer has a density less than, or equal to, 0.950 g/cc, further less than, or equal to, 0.945 g/cc, further less than, or equal to, 0.940 g/cc. In a further embodiment, the high molecular weight ethylene-based polymer is an ethylene-based interpolymer, and further a copolymer.

In one embodiment, the high molecular weight ethylene-based polymer has a density greater than, or equal to, 0.925 g/cc, further greater than, or equal to, 0.930 g/cc, further greater than, or equal to, 0.935 g/cc. In a further embodiment, the high molecular weight ethylene-based polymer is an ethylene-based interpolymer, and further a copolymer.

In one embodiment, the density of the high molecular weight ethylene-based polymer is from 0.925 to 0.950 g/cc, further from 0.930 to 0.945 g/cc, further from 0.935 to 0.940 g/cc. In a further embodiment, the high molecular weight ethylene-based polymer is an ethylene-based interpolymer, and further a copolymer.

In one embodiment, the high molecular weight ethylene-based polymer has a high load melt index, I₂₁ (190° C., 21.6 kg weight), less than, or equal to, 10 g/10 min, further less than, or equal to, 5 g/10 min, further less than, or equal to, 2 g/10 min, further less than, or equal to, 1 g/10 min. In a further embodiment, the high molecular weight ethylene-based polymer is an ethylene-based interpolymer, and further a copolymer.

In one embodiment, the high molecular weight ethylene-based polymer has a high load melt index (I₂₁) greater than, or equal to, 0.1 g/10 min, further greater than, or equal to, 0.3 g/10 min, further greater than, or equal to, 0.5 g/10 min. In a further embodiment, the high molecular weight ethylene-based polymer is an ethylene-based interpolymer, and further a copolymer.

In one embodiment, the high molecular weight ethylene-based polymer has a high load melt index (I₂₁) from 0.1 to 10 g/10 min, further from 0.3 to 5 g/10 min, further from 0.5 to 2 g/10 min. In a further embodiment, the high molecular weight ethylene-based polymer is an ethylene-based interpolymer, and further a copolymer.

As understood in the art, the high molecular weight polymer component has a higher molecular weight than the low molecular weight polymer component, as determined by the polymerization conditions of each component, melt index, Gel Permeation Chromatography and/or other methods known in the art.

In one embodiment, the weight average molecular weight Mw (of the high molecular weight ethylene-based polymer) is greater than the weight average molecular weight Mw (of the low molecular weight ethylene-based polymer).

In one embodiment, the high molecular weight ethylene-based polymer is an ethylene/α-olefin interpolymer, and further an ethylene/α-olefin copolymer. In a preferred embodiment, the α-olefin is a C3-C20 α-olefin, further a C4-C20 α-olefin, further a C4-C12 α-olefin, further a C4-C8 α-olefin, and further a C6-C8 α-olefin.

Suitable α-olefins include those containing 3 to 20 carbon atoms (C3-C20), further containing 4 to 20 carbon atoms (C4-C20), further containing 4 to 12 carbon atoms (C4-C12), further containing 4 to 8 carbon atoms (C4-C8), and further containing 6 to 8 carbon atoms (C6-C8). The α-olefins include, but are not limited to, propylene 1-butene, 1-pentene, 1-hexene, 4-methyl-1-pentene, 1-heptene, and 1-octene. Preferred α-olefins include propylene, 1-butene, 1-hexene, and 1-octene, further 1-butene, 1-hexene, and 1-octene. Especially preferred α-olefins include 1-hexene and 1-octene, and further 1-hexene. The α-olefin is desirably a C3-C8 α-olefin, and more desirably a C4-C8 α-olefin, and most desirably C6-C8 α-olefin.

Interpolymers include ethylene/butene (EB) copolymers, ethylene/hexene-1 (EH) copolymers, ethylene/octene-1 (EO) copolymers, ethylene/alpha-olefin/diene modified (EAODM) interpolymers such as ethylene/propylene/diene modified (EPDM) interpolymers and ethylene/propylene/octene terpolymers. Preferred copolymers include EB, EH and EO copolymers, and most further EH and EO copolymers.

In one embodiment, the high molecular weight ethylene-based interpolymer is an ethylene/1-hexene interpolymer, further an ethylene/1-hexene copolymer.

The high molecular weight ethylene-based polymer may comprise a combination of two or more embodiments as described herein.

### The Low Molecular Weight (LMW) Polymer Component

In one embodiment, the low molecular weight ethylene-based polymer has a density greater than, or equal to, 0.958 g/cc, further greater than, or equal to 0.962 g/cc, further greater than, or equal to, 0.965 g/cc, further greater than, or equal to, 0.968 g/cc. In a further embodiment, the low molecular weight ethylene-based polymer is an ethylene-based interpolymer, and further a copolymer. In another embodiment, the low molecular weight ethylene-based polymer is a polyethylene homopolymer.

In one embodiment, the low molecular weight ethylene-based polymer has a density less than, or equal to, 0.980 g/cc, further less than, or equal to, 0.978 g/cc, further less than, or equal to, 0.975 g/cc. In a further embodiment, the low molecular weight ethylene-based polymer is an ethylene-based interpolymer, and further a copolymer. In another embodiment, the low molecular weight ethylene-based polymer is a polyethylene homopolymer.

In one embodiment, the low molecular weight ethylene-based polymer has a density from 0.958 to 0.980 g/cc, further from 0.962 to 0.978 g/cc, further from 0.965 to 0.975 g/cc, further from 0.968 to 0.975 g/cc. In a further embodiment, the low molecular weight ethylene-based polymer is an ethylene-based interpolymer, and further a copolymer. In another embodiment, the low molecular weight ethylene-based polymer is a polyethylene homopolymer.

In one embodiment, the low molecular weight ethylene-based polymer has a melt index, I₂ (190° C., 2.16 kg weight), greater than, or equal to, 300 g/10 min, further greater than, or equal to, 350 g/10 min, further greater than, or equal to, 400 g/10 min. In a further embodiment, the low molecular weight ethylene-based polymer is an ethylene-based interpolymer, and further a copolymer. In another embodiment, the low molecular weight ethylene-based polymer is a polyethylene homopolymer.

In one embodiment, the low molecular weight ethylene-based interpolymer has a melt index, I₂, less than, or equal to, 900 g/10 min, further less than, or equal to, 850 g/10 min, further less than, or equal to, 800 g/10 min. In a further embodiment, the low molecular weight ethylene-based polymer is an ethylene-based interpolymer, and further a copolymer. In another embodiment, the low molecular weight ethylene-based polymer is a polyethylene homopolymer.

In one embodiment, the low molecular weight ethylene-based polymer has a melt index (I₂) from 300 to 900 g/10 min, further from 350 to 850 g/10 min, further from 400 to 800 g/10 min. In a further embodiment, the low molecular weight ethylene-based polymer is an ethylene-based interpolymer, and further a copolymer. In another embodiment, the low molecular weight ethylene-based polymer is a polyethylene homopolymer.

In one embodiment, the low molecular weight ethylene-based polymer is an ethylene/α-olefin interpolymer, and further a copolymer. In a preferred embodiment, the α-olefin is a C3-C20 α-olefin, further a C4-C20 α-olefin, further a C4-C12 α-olefin, further a C4-C8 α-olefin, and further C6-C8 α-olefin. The α-olefins include, but are not limited to, propylene 1-butene, 1-pentene, 1-hexene, 4-methyl-1-pentene, 1-heptene, and 1-octene.

Preferred α-olefins include propylene, 1-butene, 1-hexene, and 1-octene. Especially preferred α-olefins include 1-hexene and 1-octene, and further 1-hexene. The α-olefin is desirably a C3-C8 α-olefin, and more desirably a C4-C8 α-olefin, and most desirably a C6-C8 α-olefin.

Interpolymers include ethylene/butene-1 (EB) copolymers, ethylene/hexene-1 (EH) copolymers, ethylene/octene-1 (EO) copolymers, ethylene/alpha-olefin/diene modified (EAODM) interpolymers such as ethylene/propylene/diene modified (EPDM) interpolymers and ethylene/propylene/octene terpolymers. Preferred copolymers include EB, EH and EO copolymers, and most preferred copolymers are EH and EO copolymers.

In one embodiment, the low molecular weight ethylene-based polymer is an ethylene/1-hexene copolymer.

In another embodiment, the low molecular weight ethylene-based polymer is a polyethylene homopolymer.

The low molecular weight ethylene-based polymer may comprise a combination of two or more embodiments as described herein.

### Additives

An inventive composition may comprise one or more additives. Additives include, but are not limited to, catalyst neutralizers, acid neutralizers, UV stabilizers, antioxidants, antistats, metal de-activators, additives to improve oxidative and/or chlorine resistance, pigments or colorants, nucleating agents, and combinations thereof. In one embodiment, the composition further comprises at least one antioxidant and at least one pigment or colorant.

### Articles

The invention provides an article comprising at least one component formed from an inventive composition. The compositions of the present invention can be used to manufacture an article, or one or more components of an article. Suitable articles include, but are not limited to, containers, such as pharmaceutical containers, cosmetic containers, household containers, small sized containers (16 oz or less); toys; computer parts; and automotive parts.

### DEFINITIONS

Unless stated to the contrary, implicit from the context, or customary in the art, all parts and percents are based on weight, and all test methods are current as of the filing date of this disclosure.

The term “composition,” as used herein, includes a mixture of materials which comprise the composition, as well as reaction products and decomposition products formed from the materials of the composition.

The term “polymer,” as used herein, refers to a polymeric compound prepared by polymerizing monomers, whether of the same or a different type. The generic term polymer thus embraces the term homopolymer and the term interpolymer as defined hereinafter. Trace amounts of impurities, such as catalyst residues, may be incorporated into and/or within the polymer.

The term “interpolymer,” as used herein, refers to polymers prepared by the polymerization of at least two different types of monomers. The generic term interpolymer thus includes copolymers (formed from two monomer types) and polymers prepared from more than two different types of monomers.

The term, “olefin-based polymer,” as used herein, refers to a polymer that comprises, in polymerized form, a majority amount of olefin monomer, for example ethylene or propylene (based on the weight of the polymer), and optionally may comprise one or more comonomers.

The term, “ethylene-based polymer,” as used herein, refers to a polymer that comprises, in polymerized form, a majority amount of ethylene monomer (based on the weight of the polymer), and optionally may comprise one or more comonomers. The term, “ethylene-based interpolymer,” as used herein, refers to an interpolymer that comprises, in polymerized form, a majority amount of ethylene monomer (based on the weight of the interpolymer), and at least one comonomer.

The term, “ethylene/α-olefin interpolymer,” as used herein, refers to an interpolymer that comprises, in polymerized form, a majority amount of ethylene monomer (based on the weight of the interpolymer), and at least one α-olefin.

The term, “ethylene/α-olefin copolymer,” as used herein, refers to a copolymer that comprises, in polymerized form, a majority amount of ethylene monomer (based on the weight of the copolymer), and an α-olefin, as the only two monomer types.

The term “ethylene homopolymer,” and like terms, as used herein, refer to a polymer polymerized in a reactor in the presence of ethylene, and in which no fresh comonomer is fed into the reactor. Fresh comonomer, as known in the art, refers to a feed source of comonomer located outside a reactor or located outside one or more reactors operated in series or parallel, and which comonomer is fed into a reactor from this outside feed source. Very low levels of comonomer, typically carried over from a prior reactor, maybe present in the reactor in which the homopolymer is polymerized. Typical “comonomer to ethylene” molar ratio is less than 0.01 (as determined by the minimum level of comonomer detected by an on-line gas chromatography instrument) in the reactor at issue.

The terms “blend” or “polymer blend,” as used herein, refer to a blend of two or more polymers. Such a blend may or may not be miscible. Such a blend may or may not be phase separated. Such a blend may or may not contain one or more domain configurations, as determined from transmission electron microscopy, light scattering, x-ray scattering, and other methods known in the art.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound whether polymeric or otherwise, unless stated to the contrary. In contrast, the term, “consisting essentially of” excludes from the scope of any succeeding recitation any other component, step or procedure, excepting those that are not essential to materiality or operability. The term “consisting of” excludes any component, step or procedure not specifically delineated or listed.

### Test Methods

### Density

Resin density was measured by the Archimedes displacement method, ASTM D 792-00, Method B, in isopropanol. Specimens were measured within one hour of molding, after conditioning in the isopropanol bath at 23° C., for eight minutes, to achieve thermal equilibrium prior to measurement. The specimens were compression molded according to ASTM D-4703-00, Annex A, with a five minutes initial heating period at about 190° C., and a 15° C./min cooling rate per Procedure C. The specimen was cooled to 45° C. in the press, with continued cooling until “cool to the touch.”

### Melt Index

Melt index measurements were performed according to ASTM D-1238-04, Condition 190° C./2.16 kg, Condition 190° C./5 kg and Condition 190° C./21.6 kg, which are known as I₂, I₅ and I₂₁, respectively. Melt flow rate is inversely proportional to the molecular weight of the polymer. Thus, the higher the molecular weight, the lower the melt flow rate, although the relationship is not linear. Melt Flow Ratio (MFR) is the ratio of melt flow rate (I₂₁) to melt flow rate (I₂), unless otherwise specified.

### Gel Permeation Chromatography (GPC)

Polymer molecular weight was characterized by high temperature triple detector gel permeation chromatography (3D-GPC). The chromatographic system consisted of a Waters (Millford, Mass.) “150° C. high temperature” chromatograph, equipped with a Precision Detectors (Amherst, Mass.) 2-angle laser light scattering detector, Model 2040, and a 4-capillary differential viscometer detector, Model 150R, from Viscotek (Houston, Tex.). The 15° angle of the light scattering detector was used for calculation purposes. Concentration was measured via an infra-red detector (IR4) from PolymerChar, Valencia, Spain.

Data collection was performed using Viscotek TriSEC software version 3, and a 4-channel Viscotek Data Manager DM400. The system was equipped with an on-line solvent degas device from Polymer Laboratories. The carousel compartment was operated at 150° C., and the column compartment was operated at 150° C. The columns were four Polymer Lab Mix-A 30 cm, 20 micron columns. The polymer solution was prepared in 1,2,4-trichlorobenzene (TCB). The samples were prepared at a concentration of 0.1 grams of polymer in 50 ml of solvent. The chromatographic solvent, and the sample preparation solvent, contained 200 ppm of butylated hydroxytoluene (BHT). Both solvent sources were nitrogen sparged. Polyethylene samples were stirred gently at 160° C. for 4 hours. The injection volume was 200 μl, and the flow rate was 1.0 ml/minute.

Calibration of the GPC column set was performed with 21 narrow “molecular weight distribution” polystyrene standards. The standards were purchased from Polymer Laboratories (now a part of Varian Inc.), Shropshire, UK. The molecular weights of the standards ranged from 580 to 8,400,000, and were arranged in six “cocktail” mixtures, with at least a decade of separation between individual molecular weights.

The polystyrene standard peak molecular weights were converted to polyethylene molecular weights using the following equation (as described in Williams and Ward, J. Polym. Sci., Polym. Let., 6, 621 (1968)):

Mpolyethylene=A×(Mpolystyrene)^{B} (1A),

where M is the molecular weight, A has a value of 0.39 and B is equal to 1.0. A first order polynomial was used to fit the respective polyethylene-equivalent calibration points.

The total plate count of the GPC column set was performed with EICOSANE (prepared at 0.04 g in 50 milliliters of TCB, and dissolved for 20 minutes with gentle agitation.) The plate count and symmetry were measured on a 200 microliter injection according to the following equations:

PlateCount=5.54*(RV at Peak Maximum/(Peak width at ½height))̂2 (2A),

where RV is the retention volume in milliliters, and the peak width is in milliliters.

Symmetry=(Rear peak width at one tenth height−RV at Peak maximum)/(RV at Peak Maximum−Front peak width at one tenth height) (3A),

where RV is the retention volume in milliliters, and the peak width is in milliliters.

The plate count for the chromatographic system (based on EICOSANE as discussed above) should be greater than 22,000, and symmetry should be between 1.00 and 1.12.

The Systematic Approach for the determination of multi-detector offsets was done in a manner consistent with that published by Balke, Mourey, et. al [Mourey and Balke, Chromatography Polym. Chpt 12, (1992) and Balke, Thitiratsakul, Lew, Cheung, Mourey, Chromatography Polym. Chpt 13, (1992)], optimizing dual detector log molecular weight results from a Dow linear polyethylene homopolymer of 115,000 g/mol molecular weight, which was measured in reference to NIST polyethylene homopolymer standard 1475, to the narrow standard column calibration results from the narrow standards calibration curve using in-house software. The molecular weight data for off-set determination was obtained in a manner consistent with that published by Zimm [Zimm, B. H., J. Chem. Phys., 16, 1099 (1948)] and Kratochvil [Kratochvil, P., Classical Light Scattering from Polymer Solutions, Elsevier, Oxford, NY (1987)]. The overall injected concentration, used for the determination of the molecular weight, was obtained from the sample infra-red area, and the infra-red detector calibration from a linear polyethylene homopolymer of 115,000 molecular weight. The chromatographic concentrations were assumed low enough to eliminate addressing 2nd Virial coefficient effects (concentration effects on molecular weight).

The calculations of Mn, Mw, and Mz, based on GPC results using the IR4 detector, were determined from the following equations:

$$\begin{matrix}\overline{Mn} = \frac{{\sum }^{i} {IR}_{i}}{{\sum }^{i} ( {IR}_{i} / {M}_{{calibration}_{i}} )} , & ( 4 A ) \\ \overline{Mw} = \frac{{\sum }^{i} ( {IR}_{i} * {Mcal}_{i} )}{{\sum }^{i} {IR}_{i}} , & ( 5 A ) \\ \overline{Mz} = \frac{{\sum }^{i} ( {IR}_{i} * {Mcal }_{i}^{2} )}{{\sum }^{i} ( {IR}_{i} * {Mcal}_{i} )} , & ( 6 A )\end{matrix}$$

where, equations 4A, 5A, and 6A are calculated from polymers prepared in solutions of TCB.

The weight percent of polymer fraction with molecular weight less than 3000 g/mole was calculated by determining the area fraction under the molecular weight distribution curve less than 3000 g/mole. The molecular weight distribution curve was obtained from Conventional GPC measurements and Equation (1A) above (where the total area of the molecular weight distribution curve is defined as 1).

In addition to the above calculations, a set of alternative Mw, Mz and M_{Z+1} [Mw (abs), Mz (abs), Mz (BB) and M_{Z+1} (BB)] values were also calculated with the method proposed by Yau and Gillespie, Polymer, 42, 8947-8958 (2001), and determined from the following equations:

$$\overline{Mw} ( abs ) = {K}_{LS} * \frac{{\sum }^{i} ( {LS}_{i} )}{{\sum }^{i} ( {IR}_{i} )} , \qquad ( 8 A )$$

where, K_{LS}=LS-MW calibration constant.

$$\begin{matrix}\overline{Mz} ( abs ) = \frac{{\sum }^{i} {IR}_{i} * {( {LS}_{i} / {IR}_{i} )}^{2}}{{\sum }^{i} {IR}_{i} * ( {LS}_{i} / {IR}_{i} )} , & ( 9 A ) \\ \overline{Mz} ( BB ) = \frac{{\sum }^{i} ( {LS}_{i} * {Mcalibration }_{i} )}{{\sum }^{i} ( {LS}_{i} )} , & ( 10 A ) \\ \overline{{M}_{Z + 1}} ( BB ) = \frac{{\sum }^{i} ( {LS}_{i} * {Mcalibration }_{i}^{2} )}{{\sum }^{i} ( {LS}_{i} * {Mcalibration }_{i} )} , & ( 11 A )\end{matrix}$$

where LSᵢ is the 15 degree LS signal, and the Mcalibration uses equation 1A, and the LS detector alignment is as described previously.

In order to monitor the deviations over time, which may contain an elution component (caused by chromatographic changes) and a flow rate component (caused by pump changes), a late eluting narrow peak is generally used as a “flow rate marker peak.” A flow rate marker was therefore established based on a decane flow marker dissolved in the eluting sample prepared in TCB. This flow rate marker was used to linearly correct the flow rate for all samples by alignment of the decane peaks. Any changes in the time of the marker peak are then assumed to be related to a linear shift in both flow rate and chromatographic slope.

Measurement of Residue Deposits (Plate-Out) from Polymer Composition

A film was made from each polymer composition, using a Dr. Collin GmbH small-scale cast film monolayer line, using a 30 mm extruder, under ambient atmosphere. The extruder heating zones were set from an inlet at 30° C. (Zone 1) to the final zone at 290° C. (Die). The temperature profile between the Zone 1 and the Die was as follows: 225° C. (Zone 2), 295° C. (Zone 3), 298° C. (Zone 4), 298° C. (Zone 5), 290° C. (Zones 6-9). The screw was run at a rate needed to make a “0.8 to 2.0 mil” thick film. The extruder was purged, for 60 minutes, with a polymer (for example, LDPE) containing no additives. The polymer composition was then extruded, and a cast film was made from the extrudate by passing the extrudate over a chill roll. Film production was continued for 120 minutes, and then stopped. The chill roll deposits were collected and analyzed for stearic acid.

### Die Lip Build Evaluation Method (DBU Test Method)

The equipment consisted of a 1″ KILLION KB 100 Single Screw extruder with three heating zones that were air cooled. The temperature profile was as follows: 350° F. (Zone 1), 450° F. (Zone 2), 500° F. (Zone 3) and 490° F. (Die). The melt temperature of the polymer melt was maintained at 467° F.±5° F. The extruder was powered by a three horse power electric motor. The extruder screw length was 635 mm. The die was 76 mm long with a 2 mm diameter single hole, which was heated by a 1 inch, 225 watt, 240 volt band heater. The composition was extruded under nitrogen atmosphere, and the polymer extrudate (a strand) exited the die, which faced the floor, and then dropped vertically to the floor.

Prior to extruding a composition, the extruder was purged with Dow LDPE 5011 for approximately 15 minutes. The LDPE was purged with the desired composition, for approximately two minutes at 110 rpm. This translated to approximately fifteen pounds per hour. The extruder was run completely empty, and then the rpm's were set to zero, the die hole was scraped clean with a razor blade, and then wiped with a copper pad. The composition was added to the feed hopper, the rpms were set to approximately 25, until the air was removed from extruder. After the air was removed, the rpms were set to 110, and a timer was started. After 45 minutes, the feed hopper was allowed to completely deplete the resin, so no more composition extruded from the die. Any organic material adhered to the die face was considered die build up, and was cut from the surface of the die and weighed to obtain the die build up amount for that composition.

### Gloss

Gloss was measured on film samples using ASTM Method D2457-13: Standard Test Method for Specular Gloss of Plastic Films and Solid Plastics. The reported value for Gloss is an average of five separate 10″×10″ film samples. For each composition, a film was made using a Dr. Collin GmbH small-scale cast film monolayer line, using a 30 mm extruder (9 Zones and a Die), under ambient atmosphere. The extruder heating zones were set from an inlet at 30° C. (Zone 1) to the final zone at 290° C. (Die). The temperature profile between the Zone 1 and the Die was as follows: 225° C. (Zone 2), 295° C. (Zone 3), 298° C. (Zone 4), 298° C. (Zone 5), 290° C. (Zones 6-9). The screw was run at a rate needed to make a “0.8 to 2.0 mil” thick film. The extruder was purged, for 60 minutes, with a polymer (for example, LDPE) containing no additives. The composition was then extruded, and a cast film was made from the extrudate by passing it over a chill roll. Film production was continued for 120 minutes, and then stopped.

### EXPERIMENTAL

The ethylene-based polymer is shown in Table 1 below.

TABLE 1
Ethylene-based Polymer

| | First Reactor | Second (Final) |
|---|---|---|
| | (HMW Polymer; | Reactor |
| | comonomer = | (Ethylene- |
| | 1-hexene)* | based polymer) |
| High Load Melt Index | 0.7 | 27 |
| (I21) g/10 min | | |
| Melt Index (I2) g/10 min | | 0.3 |
| I21/I2 | | 90 |
| Density, g/cc | 0.938 | 0.958 |

*Split = 50 wt % HMW, based on sum weight of HMW and LMW.
Density of LMW from 0.965-0.975 g/cc. Melt index (I2) of LMW from 400-800 g/10 min.

The composition was formed from the following components (each ppm amount based on the weight of the composition): ethylene-based polymer (see Table 1), calcium stearate at 1000 ppm, and DYNAMAR Polymer Processing Additive FX-5920B (available from 3M; 20-30 wt % of vinylidene fluoride hexafluoropropylene polymer, 55-65 wt % polyethylene oxide, and barium sulfate, talc and calcium carbonate (see MSDS for this processing additive)) at 150 ppm. This composition is well suited for blow molding applications.

The following formulations, as shown in Table 2, were tested for Die Build Up (DBU), stearic acid plate-out, and Gloss. The ethylene-base polymer was CONTINUUM DMDA 6620 NT7 Bimodal High Density Resin (density=0.958 g/cc; 121=27 g/10 min; stabilized with ppm amounts of one or more antioxidants), available from The Dow Chemical Company. Calcium stearate was added to each composition at 1000 ppm, based on the weight of the composition. Results are shown in Tables 2 and 3.

TABLE 2
Compositions (each ppm amount based on weight of composition)

| | | | | Stearic |
|---|---|---|---|---|
| | vinylidene fluoride- | polyethylene | DBU | Acid |
| EX. | hexafluoropropylene polymer | oxide | (mg) | (mg) |
| A | 8-12 ppm* | 22-26 ppm* | 2.3 | 1.3 |
| B | 160-240 ppm* | 440-520 ppm* | 1.9 | 1.6 |
| 1 | 80-120 ppm* | 220-260 ppm* | 1.8 | 1.6 |
| C | 12-18 ppm* | 33-39 ppm* | 3.4 | 1.6 |
| 2 | 32-48 ppm* | 88-104 ppm* | 1.9 | 1.6 |
| D | 40-41 ppm** | 0 | 11.6 | 1.1 |

*DYNAMAR Polymer Processing Additive FX-5920B (see above).
**DYNAMAR Polymer Processing Additive FX-9613 (88-92 wt % vinylidene fluoride hexafluoropropylene polymer).

TABLE 3
Gloss Results

| | 20° Gloss | 45° Gloss | 60° Gloss | 85° Gloss |
|---|---|---|---|---|
| EX. | Mean ± SD | Mean ± SD | Mean ± SD | Mean ± SD |
| A | 2.62 ± 0.04 | 12.20 ± 0.21 | 7.78 ± 0.04 | 16.10 ± 0.26 |
| B | 2.78 ± 0.04 | 13.28 ± 0.23 | 8.72 ± 0.13 | 18.86 ± 0.42 |
| 1 | 2.42 ± 0.04 | 11.38 ± 0.15 | 7.72 ± 0.08 | 19.38 ± 0.41 |
| C | 2.62 ± 0.04 | 12.30 ± 0.14 | 8.16 ± 0.05 | 17.68 ± 0.16 |
| 2 | 2.52 ± 0.04 | 11.74 ± 0.09 | 7.76 ± 0.05 | 16.20 ± 0.75 |
| D | 2.56 ± 0.05 | 11.88 ± 0.15 | 7.80 ± 0.07 | 15.96 ± 0.49 |

As seen in Tables 2 and 3, the inventive compositions 1 and 2 had better overall properties, as compared to the comparative compositions A-D. The inventive compositions had lower Die Build Up (DBU), and overall lower gloss over 20 to 85 degrees. Inventive composition 2 had better (lower) gloss values at 85 degrees, as compared to inventive composition 1.

The inventive compositions can be used to form extrusion blow molded containers, with a reduction in deposit build-up on the molds and blow pins due to calcium stearate by-products and other by-products from the extrusion process. When high levels of extrusion by-products deposit in molds and blow pins, defects are typically seen on the surfaces of the extruded containers (or bottles). High levels of a fluoropolymer can be used to help reduce these deposits; however the resulting containers typically have high gloss levels. It has been discovered that the inventive compositions can be used to reduce Gloss levels, and to reduce die build-up levels, while maintaining low levels of stearic acid plate out. The inventive compositions can be used to form extrusion blow molded containers with improved surface appearance.

1. A composition comprising at least the following components:
A) an ethylene-based polymer comprising the following properties:
a) a high load melt index (I21) from 10 to 100 g/10 min,
b) a density from 0.940 to 0.965 g/cc;
B) from 20 ppm to 120 ppm, based on the weight of the composition, of at least one fluoropolymer comprising, in polymerized form, at least one vinylidene fluoride monomeric unit and at least one hexafluoropropylene monomeric unit;
C) at least one polyalkylene oxide; and
D) from 500 ppm to 2000 ppm, based on the weight of the composition, of at least one metal stearate.

2. The composition of claim 1, wherein component B is selected from the following: i) a poly(vinylidene fluoride-co-hexafluoropropylene), ii) a poly(vinylidene fluoride-co-hexafluoropropylene-co-tetrafluoroethylene), or iii) a combination thereof.

3. The composition of claim 1, wherein component D is selected from the following: calcium stearate, magnesium stearate, potassium stearate, zinc stearate, or combinations thereof.

4. The composition of claim 1, wherein the polyalkylene oxide is selected from Formula 2: 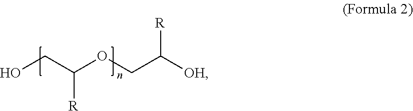
wherein each R is, independently, H, CH₃ or CH₂CH₃; and n is from 2 to 100,000.

5. The composition of claim 1, wherein the polyalkylene oxide is polyethylene oxide.

6. The composition of claim 1, wherein component C is present in an amount from 50 ppm to 200 ppm, based on the weight of the composition.

7. The composition of claim 1, wherein the weight ratio of component D to component B is from 15 to 100.

8. The composition of claim 1, wherein the ethylene-based polymer of component A has a density from 0.950 to 0.960 g/cc.

9. The composition of claim 1, wherein the ethylene-based polymer of component A has a high load melt index (I21) from 10 to 50 g/10 min.

10. The composition of claim 1, wherein the ethylene-based polymer comprises a high molecular weight polymer component and a low molecular weight polymer component.

11. The composition of claim 1, wherein the ethylene-based polymer is an ethylene/α-olefin interpolymer.

12. The composition of claim 11, wherein the α-olefin is selected from the group consisting of propylene, 1-butene, 1-hexene, and 1-octene.

13. An article comprising at least one component formed from the composition of claim 1.
